(19) United States
(12) Patent Application Publication
(10) Pub. No.: US 2007/0249356 A1
(43) Pub. Date: Oct. 25, 2007

(54) Cellular communication network resource release system

(75) Inventors: Shawn K. Dumser, Plainfield, IL (US); Terry Jacobson, Deerfield, IL (US); Karen Lee Redell, Naperville, IL (US); Harold R. Smith JR., Oakbrook Terrace, IL (US)

Correspondence Address: LUCENT TECHNOLOGIES, INC.;C/O PATTON BOGGS LLP, 1801 CALFORNIA STREET, SUITE 4900, DENVER, CO, 80202, US

(73) Assignee: Lucent Technologies, Inc., Murray Hill, NJ (US)

(21) Appl. No.: 11/408,637

(22) Filed: Apr. 21, 2006

(51) Int. Cl. H04Q 7/20

(52) U.S. Cl. 455/445; 455/428; 455/433

(57) ABSTRACT

The resource release system minimizes the time that the Mobile Switching Centers in a call initiation process commit resources after the call is terminated. This is accomplished by propagating a Call Release message through the cellular network from the Originating Mobile Switching Center to the Serving Mobile Switching Center as soon as the termination of the call initiation process is determined by the Originating Mobile Switching Center. As the Call Release message is propagated through the cellular network, each Mobile Switching Center that receives the message immediately propagates the message along the path through the cellular network toward the Serving Mobile Switching Center and releases the network resources that have been reserved for this call initiation process, thereby minimizing the amount of time network resources are maintained in a held state for this call initiation.

### FIELD OF THE INVENTION

This invention relates to cellular communication networks and to a system that immediately releases communication resources in a multi-Mobile Switching Center call connection process if a call initiation is terminated.

### BACKGROUND OF THE INVENTION

It is a problem in the field of cellular communication networks that during the call initiation process to serve an incoming call from a calling party to a called Mobile Station, where multiple Mobile Switching Centers are used, the destination or Serving Mobile Switching Center is not aware of the status of the calling party. In particular, when the calling party initiates a call to a Mobile Station that is presently served by a Mobile Switching Center (Serving Mobile Switching Center) other than their home Mobile Switching Center (Originating Mobile Switching Center), the call initiation process executes in the various Mobile Switching Centers in a loosely coupled manner. If the call initiation is terminated, there is a window of time during which the cellular network resources in the various Mobile Switching Centers are allocated, but not in use, since the calling party has disconnected from the call connection or the call has terminated for some other reason. This occurs since two or more Mobile Switching Centers are involved in extending the call from the Originating Mobile Switching Center to the Serving Mobile Switching Center, but during this window of time, only the initial (Originating) Mobile Switching Center is aware of the call termination. The call connection resources, therefore, are held in an active but unused state until the call termination is presumed by each of the Mobile Switching Centers involved in the call connection due to the expiration of a timer, and they can release the resources that were allocated for the call connection. This use of network resources is wasteful and costs the service provider in lost revenue and the unavailability of equipment needed to serve other calls, so the more efficient utilization of the call connection resources represents a significant advantage in cellular network operating efficiency.

### BRIEF SUMMARY OF THE INVENTION

The above-described problems are solved and a technical advance achieved by the present cellular communication network resource release system (termed “resource release system” herein), which minimizes the time that the Mobile Switching Centers in a call initiation process commit resources after the call is terminated. This is accomplished by propagating a Call Release message through the cellular network from the Originating Mobile Switching Center to the Serving Mobile Switching Center as soon as the termination of the call initiation process is determined by the Originating Mobile Switching Center. As the Call Release message is propagated through the cellular network each Mobile Switching Center that receives the message immediately propagates the message along the path through the cellular network toward the Serving Mobile Switching Center and releases the network resources that have been reserved for this call initiation process, thereby minimizing the amount of time network resources are maintained in a held state for this call initiation.

### BRIEF DESCRIPTION OF THE DRAWINGS

FIG. 1 illustrates, in block diagram form, the configuration of a typical cellular communication network that has a border service area between multiple adjacent Mobile Switching Centers;

FIG. 2 illustrates, in message flow form, the message flow used in existing cellular communication networks to establish a call connection from a calling party to a called Mobile Station;

FIG. 3 illustrates, in message flow form, the message flow used in existing cellular communication networks to establish a call connection from a calling party to a called Mobile Station, where the Mobile Station has roamed to a Border Mobile Switching Center, and

FIG. 4 illustrates, in message flow form, the message flow used in the present resource release system to establish a call connection from a calling party to a called Mobile Station, where the Mobile Station has roamed to a Border Mobile Switching Center, and the efficient termination of this call connection.

### DETAILED DESCRIPTION OF THE INVENTION

Cellular mobile communication systems provide the service of connecting mobile communication customers, each having a mobile subscriber station, to both land-based customers who are served by the common carrier public telephone network and other mobile communication customers. In such a system, if the traffic is circuit switched, all incoming and outgoing calls are routed through Mobile Switching Centers (MSCs), each of which is connected to a plurality of cell sites, which communicate with mobile subscriber stations located in the areas covered by the cell sites.

The terms “cell site” and “cell” are sometimes loosely used in the literature, and the term “cell site” generally denotes the locus at which the transmitter and receiver apparatus is located, while the term “cell” generally denotes the region of space served by a particular transmitter-receiver pair which is installed at a cell site. The particular technology used to implement the communications between mobile subscriber stations and the transmitter-receiver pairs, as well as the nature of the data transferred there between, be it voice, video, telemetry, computer data, and the like, are not limitations to the system which is described herein, since a novel system concept is disclosed versus a specific technologically limited implementation of an existing system concept. Therefore, the term “cellular” as it is used herein denotes a communication system which operates on the basis of dividing space into a plurality of volumetric sections or cells, and managing communications between mobile subscriber stations located in the cells and the associated transmitter-receiver pairs located at the cell site for each of these cells.

The “mobility” in mobile communications is enabled via two communication channels between the cell and the mobile subscriber station: the paging channel and the access channel. The paging channel is used to verify the location of the mobile subscriber station within the network and to deliver the incoming calls and text messages to the mobile subscriber station. The access channel is used by the mobile subscriber station for registration (to report power up, to report changes in location, etc).

Cellular Communication Network Architecture

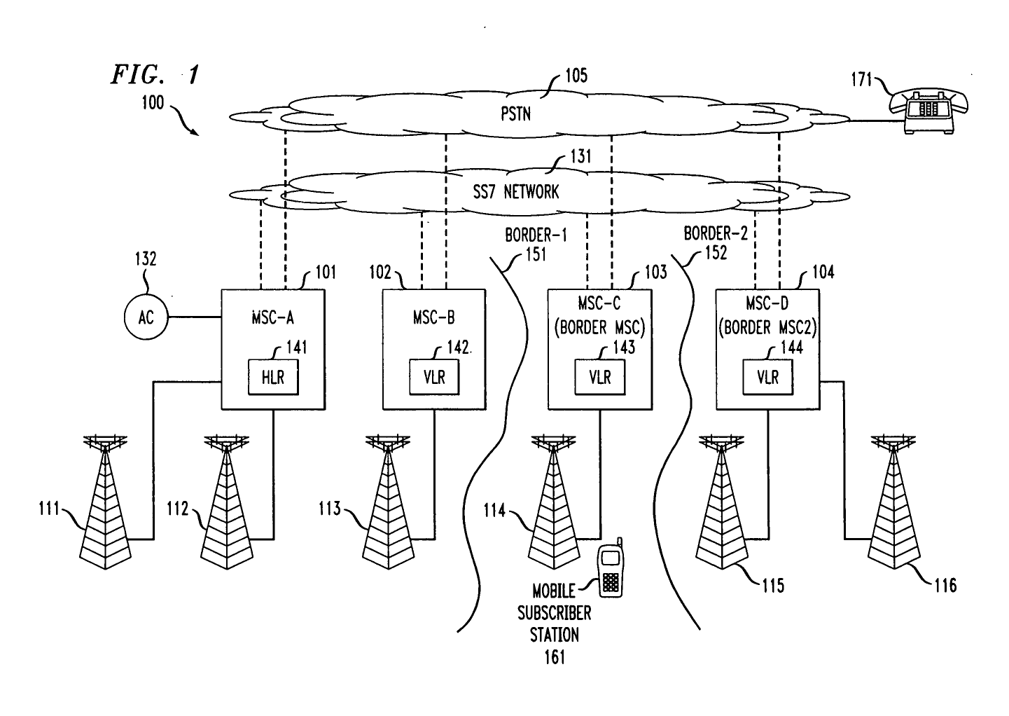

FIG. 1 illustrates, in block diagram form, the configuration of a typical cellular communication network that has a border service area between multiple adjacent Mobile Switching Centers. A cellular communication network 100 consists of a plurality of Mobile Switching Centers 101-104, each of which serves one or more Base Station Subsystems (such as 111-116) that provide the radio frequency links to the plurality of mobile subscriber stations 121, 161 that are operational in each call coverage area (termed “cell”) (not shown) provided by the associated Base Station Subsystem. One Mobile Switching Center 101 is typically termed the subscriber's home Mobile Switching Center, and it maintains the subscriber's identification, authentication, and call services definition data in an associated Home Location Register (HLR) 141, which works in coordination with the Home Authentication Center (AC). Other Mobile Switching Centers 102, 103, 104 maintain their own HLR (not shown) and Visited Location Registers (VLRs) 142, 143, 144 to store call authorization data for subscribers who roam out of their home service area to the call coverage area of the visited Mobile Switching Centers 102, 103, 104. Alternatively, the Home Location Register could be a Standalone Home Location Register (SHLR). The Mobile Switching Centers 101-104 are interconnected by an SS-7 Network 131 that serves to exchange control messages among the various Mobile Switching Centers 101-104 to manage the provision of call connections to the mobile stations 121, 161. In addition, each Mobile Switching Center 101-104 is also connected to the Public Switched Telephone Network 105 to provide call connections among the mobile stations 121, 161, and with other subscriber stations (not shown) served by the Public Switched Telephone Network 105 and other Mobile Switching Centers.

In the case of a border service area, this is the area where the service from a first Mobile Switching Center overlaps the service provided by a second Mobile Switching Center, as indicated in FIG. 1 by lines 151, 152. This situation occurs because the cell site radio frequency signals transmitted by the various Base Station Subsystems served by the Mobile Switching Centers are not precisely bounded; and to provide continuity of service to the mobile subscribers, the radio frequency signals from one Base Station Subsystem must overlap with the radio frequency signals from an adjacent Base Station Subsystem. Therefore, the mobile subscriber's mobile subscriber station is designed to select the Base Station Subsystem producing the strongest signal to ensure reliable communications as the subscriber roams among multiple cell sites.

In this environment, when the mobile subscriber's movements cause the mobile subscriber's mobile subscriber station to switch among cell sites on a frequent basis (termed “border condition” herein). The mobile subscriber is unaware of this process, and it represents a cellular communication network administrative process that is required to accurately record the present location of the mobile subscriber's mobile subscriber station in the cellular communication network for call routing purposes, and to provide the mobile subscriber with the set of features for which they are enrolled.

Call Initiation in a Cellular Network—Multiple Mobile Switching Centers

During the call initiation process to serve an incoming call from a calling party to a called Mobile Station through multiple Mobile Switching Centers, the destination or Serving Mobile Switching Center is not aware of the status of the calling party. In particular, when the calling party initiates a call to a Mobile Station that is presently served by a Mobile Switching Center (Serving Mobile Switching Center) other than their home Mobile Switching Center (Originating Mobile Switching Center), the call initiation process executes in the various Mobile Switching Centers in a loosely coupled manner. If the call initiation is terminated, there is a window of time during which the cellular network resources in the various Mobile Switching Centers are allocated, but not in use, since the calling party has disconnected from the call connection or the call has terminated for some other reason. This occurs since two or more Mobile Switching Centers are involved in extending the call from the Originating Mobile Switching Center to the Serving Mobile Switching Center, but during this window of time, only the initial (Originating) Mobile Switching Center is aware of the call termination. The call connection resources, therefore, are held in an active but unused state until the call termination is presumed by each of the Mobile Switching Centers involved in the call connection due to the expiration of a timer, and they can release the resources that were allocated for the call connection. This use of network resources is wasteful and costs the service provider in lost revenue and the unavailability of equipment needed to serve other calls, so the more efficient utilization of the call connection resources represents a significant advantage in cellular network operating efficiency.

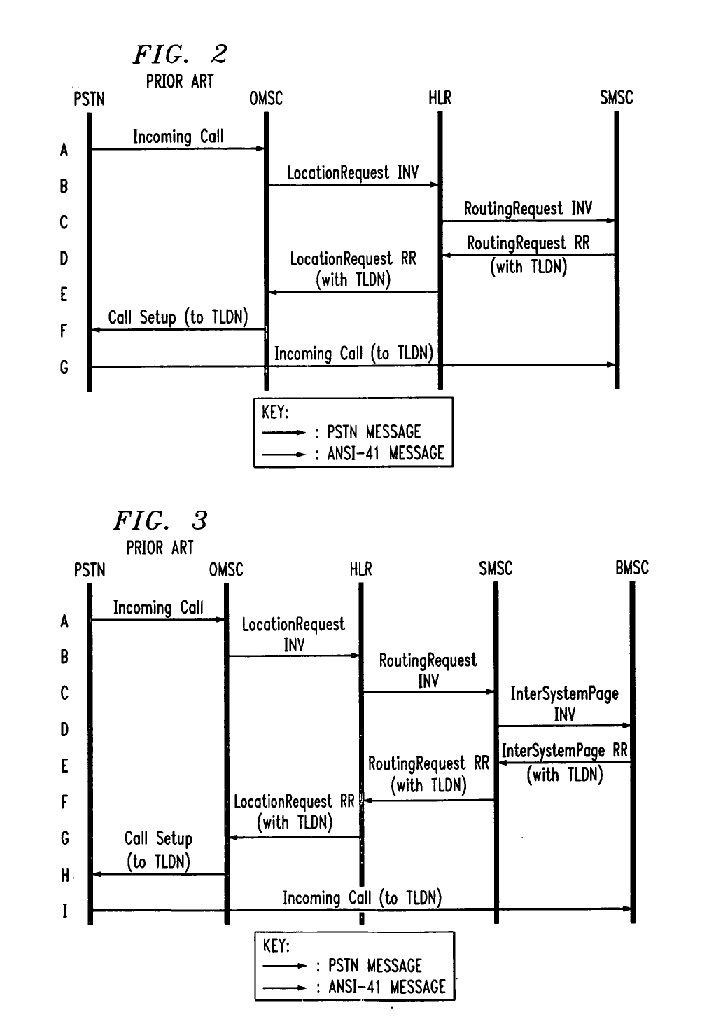

FIG. 2 illustrates, in message flow form, the message flow used in existing cellular communication networks to establish a call connection from a calling party 171 to a called Mobile Station 121. The incoming call is directed from the calling party 171 through the Public Switched Telephone Network 105 in FIG. 1 to the Originating Mobile Switching Center 101, which is the home location of the called Mobile Station 121. This call origination is represented by the signal flow of Line A in FIG. 2. The Originating Mobile Switching Center 101, in response to receipt of the incoming call, queries the Home Location Register 141 of the called Mobile Station 121 using a Location Request Invoke as shown in Line B in FIG. 2, to determine the present location of the called Mobile Station 121. The Home Location Register 141 determines the present location of the called Mobile Station 121 by retrieving the present location data from memory that indicates the identity of the Serving Mobile Switching Center 102 that is presently serving the called Mobile Station 121, or was the last Mobile Switching Center that had served the called Mobile Station 121. In the present example, the called Mobile Station 121 is roaming and is now being served by another Mobile Switching Center, termed the Serving Mobile Switching Center 102. The Home Location Register 141, therefore, must retrieve the requested location information for the called Mobile Station 121 by transmitting a Routing Request over the SS7 Network 131 to the Serving Mobile Switching Center 102 to affirmatively determine the present location of the called Mobile Station 121 as shown in Line C in FIG. 2. At this juncture, if the Serving Mobile Switching Center 102 locates the called Mobile Station 121 via paging and has the proper provisioning to establish the call connection, the Serving Mobile Switching Center 102 returns a Temporary Local Directory Number (TLDN) via a Routing Request Return Result message transmitted over the SS7 Network 131 to the Home Location Register 141 as shown in Line D of FIG. 2. The Temporary Local Directory Number is relayed by the Home Location Register 141 to the Originating Mobile Switching Center 101 via the Location Request Return Result message as shown in Line E in FIG. 2. The Originating Mobile Switching Center 101, in response to receipt of the Location Request Return Result message, sets up the call connection to the identified Temporary Local Directory Number as shown in Line F of FIG. 2, which call connection is established from Mobile Switching Center 101 through the Public Switched Telephone Network 105 to the Serving Mobile Switching Center 102 as shown in Line G of FIG. 2. The Serving Mobile Switching Center 102 then extends this call connection in the traditional manner to the called Mobile Station 121 that is served by the Serving Mobile Switching Center 102.

A problem with the operation of the cellular communication network as detailed above is that the Originating Mobile Switching Center 101 has no means of notifying the Serving Mobile Switching Center 102 if the call has been terminated. Once the Originating Mobile Switching Center 101 initiates the call connection by transmitting the Location Request Invoke at Line B of FIG. 2, the calling party can disconnect or the call can terminate for any other reason, and the Serving Mobile Switching Center 102 continues to process this request and return the result of its processing to the Originating Mobile Switching Center 101, as shown in Lines GE of FIG. 2, even though the Originating Mobile Switching Center 101 will simply discard this result, since the incoming call is terminated. The processing executed by the Serving Mobile Switching Center 102 may include paging to locate the called Mobile Station 101, the reservation of a Temporary Local Directory Number, the allocation of radio (traffic channel) resources, as well as other administrative activities. These resources are used and allocated for this call connection until the Serving Mobile Switching Center 102 determines that the call has been terminated, which typically is accomplished by the expiration of a timer, which the Serving Mobile Switching Center 102 uses to wait for an incoming call directed to the Temporary Local Directory Number, with this time period potentially extending for many seconds. If no call is directed to the Temporary Local Directory Number during that time interval, it is assumed that the call has been terminated and the Serving Mobile Switching Center 102 releases the network resources that have been allocated to serve this incoming call.

Call Initiation in a Cellular Network—Border Mobile Switching Centers

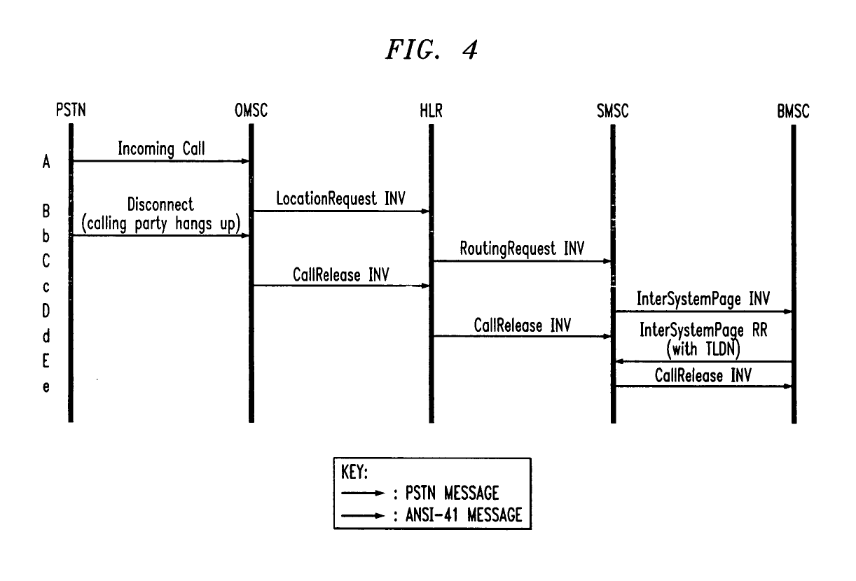

FIG. 3 illustrates, in message flow form, the message flow used in existing cellular communication networks to establish a call connection from a calling party 171 to a called Mobile Station 161. The incoming call is directed from the calling party 171 through the Public Switched Telephone Network 105 to the Originating Mobile Switching Center 101, which is the home location of the called Mobile Station 161. This call origination is represented by the signal flow of Line A in FIG. 3. The Originating Mobile Switching Center 101, in response to receipt of the incoming call, queries the Home Location Register 141 of the called Mobile Station 161 using a Location Request Invoke as shown in Line B of FIG. 3, to determine the present location of the called Mobile Station 161. The Home Location Register 141 determines the present location of the called Mobile Station 161 by retrieving the present location data from memory that indicates the identity of the Serving Mobile Switching Center 102 that is presently serving the called Mobile Station 161, or was the last Mobile Switching Center that had served the called Mobile Station 161. In the present example, the called Mobile Station 161 is roaming and is now being served by another Mobile Switching Center, termed the Serving Mobile Switching Center 102. The Home Location Register 141, therefore, must retrieve the requested location information for the called Mobile Station 161 by transmitting a Routing Request over the SS7 Network 131 to the Serving Mobile Switching Center 102 as shown in Line C of FIG. 3. At this juncture, the Serving Mobile Switching Center 102 locates the called Mobile Station 161 by retrieving the location information from the VLR 142, which indicates that the called Mobile Station 161 may have roamed to the service area of another Mobile Switching Center 103 (termed a “Border Mobile Switching Center”). The Serving Mobile Switching Center 102 originates an InterSystem Page Invoke message over the SS7 Network 131 to the Border Mobile Switching Center 103 as shown in Line D of FIG. 3 to locate the called Mobile Station 161. If the Border Mobile Switching Center 103 locates the called Mobile Station 161 and has the proper provisioning to establish the call connection, the Border Mobile Switching Center 103 returns a Temporary Local Directory Number (TLDN) via an InterSystem Page Return Result message over the SS7 Network 131 to the Serving Mobile Switching Center 102 as shown in Line E of FIG. 3. The Serving Mobile Switching Center 102, in response to the receipt of the InterSystem Return Result message generates a Routing Request Return Result message with the TLDN from MSC 103, which is transmitted over the SS7 Network 131 to the Home Location Register 141 as shown in Line F of FIG. 3. The Temporary Local Directory Number is relayed by the Home Location Register 141 to the Originating Mobile Switching Center 101 via the Location Request Return Result message as shown in Line G of FIG. 3. The Originating Mobile Switching Center 101, in response to receipt of the Location Request Return Result message, sets up the call connection to the identified Temporary Local Directory Number at Line H of FIG. 3, which call connection is established through the Public Switched Telephone Network 105 to the Border (new Serving) Mobile Switching Center 103 as shown in Line I of FIG. 3. The Border/Serving Mobile Switching Center 103 then extends this call connection in the traditional manner to the called Mobile Station 161 that is served by the Border/Serving Mobile Switching Center 103.

A problem with the operation of the cellular communication network as detailed above is that the Originating Mobile Switching Center 101 has no means of notifying the Serving Mobile Switching Center 102, or Border MSC 103 if the call has been terminated. Once the Originating Mobile Switching Center 101 initiates the call connection by transmitting the Location Request Invoke at Line B of FIG. 3, the calling party can disconnect or the call can terminate for any other reason, the Serving Mobile Switching Center 102 and the Border Mobile Switching Center 103 continue to process this request and return the result of its processing to the Originating Mobile Switching Center 101, as shown in Lines C-G in FIG. 3, even though the Originating Mobile Switching Center 101 will simply discard this result, since the incoming call is terminated. The processing executed by the Serving Mobile Switching Center 102 and/or Border Mobile Switching Center 103 may include paging to locate the called Mobile Station 161, the reservation of a Temporary Local Directory Number, the allocation of radio (traffic channel) resources, as well as other administrative activities. These resources are used and allocated for this call connection until the Serving Mobile Switching Center 102 or the Border Mobile Switching Center 103 determine that the call has been terminated, which typically is accomplished by the expiration of a timer, waiting for an incoming call directed to the Temporary Local Directory Number, with this time period potentially extending for many seconds. If no call is directed to the Temporary Local Directory Number during that time interval, it is assumed that the call has been terminated and the Serving MSC 102 or Border Mobile Switching Center 103 releases the network resources that have been allocated to serve this incoming call.

Operation of the Resource Release System

FIG. 4 illustrates, in message flow form, the message flow used in the present resource release system to establish a call connection from a calling party 171 to a called Mobile Station 161. As shown in FIG. 1, the incoming call is directed from the calling party 171 through the Public Switched Telephone Network 105 to the Originating Mobile Switching Center 101, which is the home location of the called Mobile Station 161. This call origination is represented by the signal flow of Line A in FIG. 4. The Originating Mobile Switching Center 101, in response to receipt of the incoming call, queries the Home Location Register 141 of the called Mobile Station 161 using a Location Request Invoke as shown in Line B of FIG. 4, to determine the present location of the called Mobile Station 161. The Home Location Register 141 determines the present location of the called Mobile Station 161 by retrieving the present location data from memory that indicates the identity of the Serving Mobile Switching Center 102 that is presently serving the called Mobile Station 161, or was the last Mobile Switching Center that had served the called Mobile Station 161. In the present example, the called Mobile Station 161 is roaming and is now being served by another Mobile Switching Center, termed the Serving Mobile Switching Center 102. The Home Location Register 141, therefore, must retrieve the requested location information for the called Mobile Station 161 by transmitting a Routing Request over the SS7 Network 131 to the Serving Mobile Switching Center 102 as shown in Line C of FIG. 4. At this juncture, the Serving Mobile Switching Center 102 locates the called Mobile Station 161 by retrieving the location information from the VLR 142 which indicates that the called Mobile Station 161 may have roamed to the service area of another Mobile Switching Center 103 (termed a “Border Mobile Switching Center”), the Serving Mobile Switching Center 102 originates an InterSystem Page Invoke message over the SS7 Network 131 to the Border Mobile Switching Center 103 as shown in Line D of FIG. 4 to locate the called Mobile Station 161. If the Border Mobile Switching Center 103 locates the called Mobile Station 161 and has the proper provisioning to establish the call connection, the Border Mobile Switching Center 103 returns a Temporary Local Directory Number (TLDN) via an InterSystem Page Return Result message over the SS7 Network 131 to the Serving Mobile Switching Center 102 as shown in Line E of FIG. 4.

However, the Originating Mobile Switching Center 101 is concurrently deconstructing the call processing in response to the receipt of a disconnect message (or other call termination) that occurs (for the sake of example) at Line b of FIG. 4. The Originating Mobile Switching Center 101 forwards the call termination information to the Home Location Register 141 by transmitting a Call Release Invoke message at Line c of FIG. 4. The Home Location Register 141 forwards the received Call Release Invoke message over the SS7 Network 131 to the Serving Mobile Switching Center 102 at Line d of FIG. 4, and the Serving Mobile Switching Center 102 terminates its processing of the called Mobile Station 161 location request, releases the network resources, and forwards the Call Release Invoke message over the SS7 Network 131 to the Border Mobile Switching Center 103 at Line e of FIG. 4. The Border Mobile Switching Center 103 terminates processing of the called Mobile Station 161 location request and releases the network resources. It maybe required that the call at Mobile Switching Center 102 can be terminated and the resources released once the Called Mobile Station 161 is found at the Border Mobile Switching Center 103, in order to maintain proper network operation. Thus, the propagation of the Call Release Invoke message causes the release of network resources that have been allocated for the processing of this call initiation, thereby making these resources available for use in other call connections.

### SUMMARY

The use of the Call Release Invoke message causes the Mobile Switching Centers in the cellular network to terminate call processing and immediately release network resources, once the Call Release Invoke message is received and forwarded through the network to the next Mobile Switching Center in the call connection.

What is claimed as new and desired to be protected by Letters Patent of the United States is:

1. A network resource release system, operable in a cellular communication network, for releasing cellular network resources on an incoming call directed to a called mobile station that has roamed out of the coverage area of an Originating Mobile Switching Center, comprising:
mobile station location determining means for identifying a Serving Mobile Switching Center in which said called mobile station is operational; and
call release means for transmitting a Call Release Invoke message to said Serving Mobile Switching Center in which said called mobile station is operational to request immediately terminating processing of said incoming call in said Serving Mobile Switching Center.

2. The network resource release system of claim 1 further comprising:
call deconstruction means, located in said Serving Mobile Switching Center and responsive to receipt of said Call Release Invoke message, for immediately terminating processing of said incoming call in said Serving Mobile Switching Center.

3. The network resource release system of claim 1 wherein said mobile station location determining means comprises:
Home Location Register query means for retrieving data indicative of said Serving Mobile Switching Center from a Home Location Register in said Originating Mobile Switching Center.

4. The network resource release system of claim 1 wherein said call release means comprises:
call release invoke message originating means, responsive to said calling party disconnecting from said incoming call, for generating a Call Release Invoke message; and
message forwarding means, located in said Home Location Register, for forwarding said Call Release Invoke message to said Serving Mobile Switching Center.

5. The network resource release system of claim 4 wherein said call release means further comprises:
border message forwarding means, located in said Serving Mobile Switching Center and responsive to receipt of said Call Release Invoke message, for forwarding the received Call Release Invoke message to a Border Mobile Switching Center that is presently serving said called Mobile Station.

6. The network resource release system of claim 5 further comprising:
call deconstruction means, located in said Border Mobile Switching Center and responsive to receipt of said Call Release Invoke message, for immediately terminating processing of said incoming call in said Border Mobile Switching Center.

7. The network resource release system of claim 5 wherein said mobile station location determining means comprises:
query means, located in a Serving Mobile Switching Center, for initiating a page request to the Border Mobile Switching Center adjacent said Serving Mobile Switching Center to locate said Mobile Station.

8. A method of releasing network resources, operable in a cellular communication network, for releasing cellular network resources on an incoming call directed to a called mobile station that has roamed out of the coverage area of an Originating Mobile Switching Center, comprising:
identifying a Serving Mobile Switching Center in which said called mobile station is operational; and
transmitting a Call Release Invoke message to said Serving Mobile Switching Center in which said called mobile station is operational to request immediately terminating processing of said incoming call in said Serving Mobile Switching Center.

9. The method of releasing network resources of claim 8 further comprising:
immediately terminating, in response to receipt of said Call Release Invoke message, processing of said incoming call in said Serving Mobile Switching Center.

10. The method of releasing network resources of claim 8 wherein said step of identifying comprises:
retrieving data indicative of said Serving Mobile Switching Center from a Home Location Register in said Originating Mobile Switching Center.

11. The method of releasing network resources of claim 8 wherein said step of transmitting comprises:
generating, in response to said calling party disconnecting from said incoming call, a Call Release Invoke message; and
forwarding said Call Release Invoke message from said Home Location Register to said Serving Mobile Switching Center.

12. The method of releasing network resources of claim 11 wherein said step of transmitting further comprises:
forwarding, in response to receipt of said Call Release Invoke message in said Serving Mobile Switching Center, the received Call Release Invoke message to a Border Mobile Switching Center that is presently serving said called Mobile Station.

13. The method of releasing network resources of claim 12 further comprising:
immediately terminating, in response to receipt of said Call Release Invoke message in said Border Mobile Switching Center, processing of said incoming call in said Border Mobile Switching Center.

14. The method of releasing network resources of claim 12 wherein said step of identifying comprises:
initiating a page request in said Serving Mobile Switching Center to the Border Mobile Switching Center adjacent said Serving Mobile Switching Center to locate said Mobile Station.
